(19) United States
(12) Patent Application Publication
(10) Pub. No.: US 2009/0228284 A1
(43) Pub. Date: Sep. 10, 2009

(54) METHOD AND APPARATUS FOR ENCODING/DECODING MULTI-CHANNEL AUDIO SIGNAL BY USING A PLURALITY OF VARIABLE LENGTH CODE TABLES

(75) Inventors: Han-gil MOON, Seoul (KR); Geon-hyoung LEE, Hwaseong-si (KR); Chul-woo LEE, Suwon-si (KR); Jong-hoon JEONG, Suwon-si (KR); Nam-suk LEE, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/397,505

(22) Filed: Mar. 4, 2009

(30) Foreign Application Priority Data
Mar. 4, 2008 (KR) 10-2008-0020068

(51) Int. Cl. G10L 19/00

(52) U.S. Cl. 704/500

(57) ABSTRACT

A method and apparatus for encoding a multi-channel audio signal is provided. The method includes the operations of selecting a first variable length code table (VLC) that is to be used to encode the multi-channel audio signal in a given frequency band, from among a plurality of VLC tables, and encoding the multi-channel audio signal by using the first VLC table. Thus, the multi-channel audio signal can be encoded by using VLC tables that differ according to frequency bands.

### CROSS-REFERENCE TO RELATED PATENT APPLICATION

This application claims priority from Korean Patent Application No. 10-2008-0020068, filed on Mar. 4, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to encoding/decoding of a multi-channel audio signal, and more particularly, to encoding/decoding of a multi-channel audio signal in consideration of probability distributions of an intensity or parameters of the multi-channel audio signal which differ according to frequency bands.

2. Description of the Related Art

Examples of a general multi-channel audio encoding method include waveform audio coding and parametric audio coding. Examples of waveform audio coding include Moving Picture Experts Group-2 (MPEG-2) multi-channel audio coding, Advanced Audio Coding (AAC) for multi-channel, Bit Sliced Arithmetic Coding (BSAC)/Audio Video Coding Standard (AVS) multi-channel audio coding, etc.

In parametric audio coding, an audio signal is divided into components, such as frequencies or amplitudes, in a frequency domain, and information about the frequencies, amplitudes, or the like is parameterized, thereby encoding the audio signal. For example, when a stereo audio signal is encoded by parametric audio coding, a left-channel audio signal and a right-channel audio signal of the stereo audio signal are down-mixed to generate a mono-audio signal, and the mono-audio signal is encoded. Then, parameters of each frequency band, such as, an interchannel intensity difference (IID), an interchannel correlation (IC), an overall phase difference (OPD), and an interchannel phase difference (IDP) are encoded. A plurality of frequency bands are obtained by dividing a frequency domain into a plurality of areas. During parametric audio coding, an encoding side encodes the aforementioned parameters of each frequency band and transmits the encoded parameters to a decoding side. The decoding side decodes the encoded parameters in order to restore the original parameters, and transforms a mono-audio signal into a stereo-audio signal on the basis of the restored parameters.

According to a related art, a multi-channel audio signal is encoded without considering a characteristic of a multi-channel audio signal which varies according to frequency bands. Thus, the multi-channel audio signal is inefficiently encoded.

### SUMMARY OF THE INVENTION

The present invention provides a method and apparatus for encoding/decoding a multi-channel audio signal in consideration of a characteristic of the multi-channel audio signal, which varies according to frequency bands, and a computer readable recording medium having recorded thereon a program for executing the method.

According to an aspect of the present invention, there is provided a method of encoding a multi-channel audio signal in a given frequency band, the method comprising the operations of selecting a first variable length code (VLC) table that is to be used to encode the multi-channel audio signal in the given frequency band, from among a plurality of VLC tables, and encoding the multi-channel audio signal by using the first VLC table.

The operation of encoding the multi-channel audio signal may comprise encoding at least one of an intensity and a parameter of the multi-channel audio signal in the given frequency band by using the first VLC table.

According to another aspect of the present invention, there is provided a method of decoding a multi-channel audio signal in a given frequency band, the method comprising the operations of selecting a first variable length decode (VLD) table that is to be used to decode the multi-channel audio signal in the given frequency band, from among a plurality of VLD tables; and decoding the multi-channel audio signal by using the first VLD table.

The operation of decoding the multi-channel audio signal may comprise decoding at least one of an intensity and a parameter of the multi-channel audio signal in the given frequency band by using the first VLD table.

According to another aspect of the present invention, there is provided an apparatus for encoding a multi-channel audio signal in a given frequency band, the apparatus comprising: a control unit selecting a first VLC table that is to be used to encode the multi-channel audio signal in the given frequency band, from among a plurality of VLC tables; and an encoding unit encoding the multi-channel audio signal by using the first VLC table.

The encoding unit may encode at least one of an intensity and a parameter of the multi-channel audio signal in the given frequency band by using the first VLC table.

According to another aspect of the present invention, there is provided an apparatus for decoding a multi-channel audio signal in a given frequency band, the apparatus comprising: a control unit selecting a first VLD table that is to be used to decode the multi-channel audio signal in the given frequency band, from among a plurality of VLD tables; and a decoding unit decoding the multi-channel audio signal by using the first VLD table.

The decoding unit may decode at least one of an intensity and a parameter of the multi-channel audio signal in the given frequency band by using the first VLD table.

The VLC or VLD tables may be Huffman code tables.

The multi-channel audio signal may be a stereo-audio signal. The parameter of the multi-channel audio signal may be a parameter for determining an intensity of a left-channel audio signal in the given frequency band and an intensity of a right-channel audio signal in the given frequency band.

The parameter for determining the intensities of the left-channel audio signal and the right-channel audio signal may be information about either an angle between a third vector associated with an intensity of a mono-audio signal and a first vector associated with an intensity of the left-channel audio signal or an angle between the third vector and a second vector associated with an intensity of the right-channel audio signal in a vector space formed so that the first and second vectors form a given angle.

The information about the angle may be either a cosine value of the angle between the first and third vectors or a cosine value of the angle between the second and third vectors.

According to another aspect of the present invention, there is provided a computer readable recording medium having recorded thereon a program for executing the above-described method of encoding/decoding a multi-channel audio signal.

### BRIEF DESCRIPTION OF THE DRAWINGS

The above and other aspects of the present invention will become more apparent by describing in detail exemplary embodiments thereof with reference to the attached drawings, in which:

FIG. 1 illustrates an apparatus for encoding a multi-channel audio signal, according to an exemplary embodiment of the present invention;

FIG. 2 illustrates frequency bands according to an exemplary embodiment of the present invention;

FIG. 3 illustrates an apparatus for encoding a multi-channel audio signal, according to another exemplary embodiment of the present invention;

FIG. 4 is a diagram for explaining a method of encoding a parameter for determining the intensities of a left-channel audio signal and a right-channel audio signal, according to an exemplary embodiment of the present invention;

FIGS. 5A and 5B are graphs illustrating probability distributions of an angle between vectors associated with intensities of a right-channel audio signal and a mono-audio signal, according to an exemplary embodiment of the present invention;

FIGS. 6A and 6B illustrate variable length code (VLC) tables according to an exemplary embodiment of the present invention;

FIG. 7 is a flowchart illustrating a method of encoding a multi-channel audio signal, according to an exemplary embodiment of the present invention;

FIG. 8 illustrates an apparatus for decoding a multi-channel audio signal, according to an exemplary embodiment of the present invention;

FIG. 9 illustrates an apparatus for decoding a multi-channel audio signal, according to another exemplary embodiment of the present invention; and

FIG. 10 is a flowchart of a method of decoding a multi-channel audio signal, according to an exemplary embodiment of the present invention.

### DETAILED DESCRIPTION OF EXEMPLARY EMBODIMENTS

The present invention will now be described more fully with reference to the accompanying drawings, in which exemplary embodiments of the invention are shown.

FIG. 1 illustrates an apparatus 100 for encoding a multi-channel audio signal, according to an exemplary embodiment of the present invention. Referring to FIG. 1, the apparatus 100 for encoding the multi-channel audio signal includes a control unit 110 and an encoding unit 120.

The control unit 110 selects a variable length code (VLC) table that is to be used to encode a multi-channel audio signal in a given frequency band, from among a plurality of VLC tables. In the exemplary embodiment of the present invention, encoding is performed using a characteristic of a multi-channel audio signal which has different values according to frequency bands. The characteristic of the multi-channel audio signal that varies according to frequency bands may be a probability distribution of an intensity value or a parameter value of the multi-channel audio signal.

The intensity of a multi-channel audio signal denotes an intensity of the multi-channel audio signal in a given frequency band on a generated power spectrum when the multi-channel audio signal is transformed into the frequency domain by fast Fourier transformation or the like. The parameter of the multi-channel audio signal denotes any parameter generated while encoding the multi-channel audio signal. Examples include an interchannel intensity difference (IID), an interchannel correlation (IC), an overall phase difference (OPD), and an interchannel phase difference (IDP), which have been described above with reference to a related art.

When illustrating the intensity of a multi-channel audio signal, a probability, that the intensity of the multi-channel audio signal in a low frequency band slightly varies according to time, is higher than a probability that the intensity of the multi-channel audio signal in a high frequency band slightly varies according to time. In other words, the intensity of a low frequency band in a previous audio frame is highly likely not to be different from that of a low frequency band in a current audio frame, and the intensity of a high frequency band in the previous audio frame is highly likely to be greatly different from that of a high frequency band in the current audio frame.

In an audio codec where prediction coding is performed in units of frames, only a residual value corresponding to a difference between the intensities of a previous audio frame and a current audio frame is encoded. Accordingly, a residual value in a low frequency band is highly likely to be ‘0’, and in a high frequency band the residual value is highly likely to be a value other than ‘0’.

Similar to the intensity of the multi-channel audio signal, the parameters thereof have different probability distributions according to frequency bands. For example, an IID of a multi-channel audio signal in a low frequency band is highly likely to be ‘0’, and an IID of the multi-channel audio signal in a high frequency band is highly likely to be large.

Therefore, it is inefficient to encode an intensity or a parameter of the multi-channel audio signal that has different probability distributions according to frequency bands by using a single VLC table as in the related art.

For example, when Huffman coding is performed, values to be encoded are mapped with codes having different lengths based on the probability of occurrence of the values to be encoded. In other words, a value less likely to be generated is mapped with a code composed of a high number of bits, and a value highly likely to be generated is mapped with a code composed of a small number of bits. Accordingly, encoding of an intensity or parameter of a multi-channel audio signal that has different probability distributions according to frequency bands by using a single Huffman code table may degrade the compression efficiency of the multi-channel audio signal.

In order to address this problem, in the exemplary embodiment of the present invention, a multi-channel audio signal is encoded using different VLC tables according to frequency bands. In order to achieve this encoding, the control unit 110 selects a VLC table suitable for a frequency band that the encoding unit 120 currently encodes, and provides the selected VLC table to the encoding unit 120.

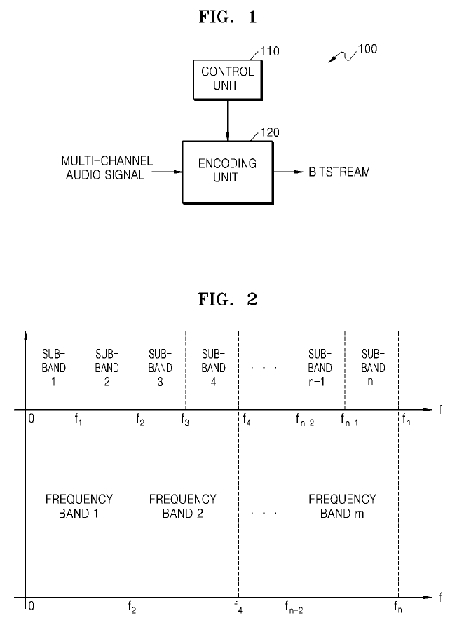

Frequency bands are set according to sub-bands. As described above, since encoding is performed in units of sub-bands in parametric audio coding, frequency bands that serve as a basis for selection of suitable VLC tables may also be set based on sub-bands. This will now be described in greater detail with reference to FIG. 2.

FIG. 2 illustrates frequency bands according to an embodiment of the present invention.

As illustrated in the upper part of FIG. 2, the control unit 110 may set frequency bands serving as a basis for the selection of VLC tables so as to be equal to a plurality of sub-bands. In other words, when the intensities or parameters of sub-band 1, sub-band 2, sub-band 3, through to sub-band n of the multi-channel audio signal are encoded, different VLC tables may be selected according to the sub-bands.

In this case, a total of n×(p+1) VLC tables are required, which are a sum of n VLC tables required to encode the intensity of the multi-channel audio signal by sub-band and n×p VLC tables required to encode p parameters of the multi-channel audio signal by sub-band. In addition, if encoding is performed using VLC tables that differ by channel, the number of VLC tables which are referred to in order to encode a multi-channel audio signal increases further.

In order to reduce the number of VLC tables, the control unit 110 may define frequency bands, which serve as a basis for selection of VLC tables, by grouping a plurality of sub-bands.

As illustrated in the lower part of FIG. 2, frequency band 1, frequency band 2, through to frequency band m may be set by grouping sub-bands by twos. For example, a same VLC table may be selected to encode the sub-bands 1 and 2 of the multi-channel audio signal.

Referring back to FIG. 1, the encoding unit 120 encodes the multi-channel audio signal in the given frequency band by using the VLC table selected by the control unit 1 10. The intensity or parameter of the multi-channel audio signal in the given frequency band is encoded. Different VLC tables are selected considering probability distributions of the intensity or parameter of the multi-channel audio signal that differ according to frequency bands. Thus, adaptive multi-channel audio encoding in consideration of the different frequency bands is possible.

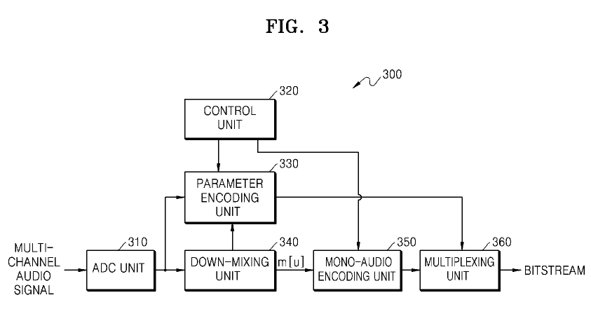

FIG. 3 illustrates a multi-channel audio encoding apparatus 300 according to another exemplary embodiment of the present invention. Referring to FIG. 3, the multi-channel audio encoding apparatus 300 includes an analog-to-digital conversion (ADC) unit 310, a control unit 320, a parameter encoding unit 330, a down-mixing unit 340, a mono-audio encoding unit 350, and a multiplexing unit 360. It is assumed that the multi-channel audio encoding apparatus 300 encodes a stereo multi-channel audio signal.

The ADC unit 310 receives an analog left-channel audio signal and an analog right-channel audio signal of the stereo multi-channel audio signal, samples and quantizes the analog left-channel and right-channel audio signals, and converts the sampled and quantized analog left-channel and right-channel audio signals into digital signals.

The control unit 320 selects a VLC table that is to be used to encode the multi-channel audio signal in a given frequency band. A VLC table is selected in consideration of probability distributions of an intensity or parameter of a mono-audio signal in the given frequency band.

The control unit 320 has a plurality of VLC tables to be used to encode intensities of the mono-audio signal and a plurality of VLC tables to be used to encode parameters of the mono-audio signal. The control unit 320 selects a VLC table that is to be used to encode a frequency band of the multi-channel audio signal that is being currently encoded by the parameter encoding unit 330 and the mono-audio encoding unit 350, from two VLC tables for two sub-bands, and provids the selected VLC table to the parameter encoding unit 330 and the mono-audio encoding unit 350.

The parameter encoding unit 330 encodes the parameter of the stereo-audio signal by using the VLC table selected by the control unit 320. The parameter of the stereo-audio signal is encoded by using VLC tables that are different according to frequency bands.

An exemplary embodiment of the present invention provides a method of encoding a parameter for determining the sizes of a left-channel audio signal and a right-channel audio signal. According to parametric audio coding, the multi-channel audio encoding apparatus 300 down-mixes a stereo-audio signal into a mono-audio signal and encodes the mono-audio signal, and encodes a separate parameter for restoring the stereo-audio signal from the mono-audio signal. In order to restore the stereo-audio signal from the mono-audio signal, parameters for determining the phases of the left-channel audio signal and the right-channel audio signal are needed together with parameters for determining the intensities of the left-channel audio signal and the right-channel audio signal.

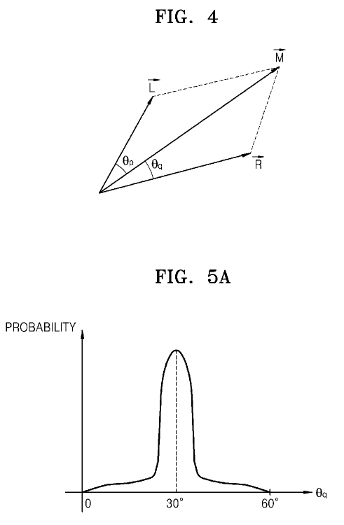

The IID and the IC from among the aforementioned parameter examples are parameters for determining the intensities of the left-channel audio signal and the right-channel audio signal. According to the related art, two parameters for determining the intensities of the left-channel audio signal and the right-channel audio signal should be encoded. However, in the exemplary embodiment of the present invention, only one parameter is used and encoded to determine the intensities of the left-channel audio signal and the right-channel audio signal. This will be described in greater detail with reference to FIG. 4.

FIG. 4 is a diagram for explaining a method of encoding a parameter for determining the intensities of a left-channel audio signal and a right-channel audio signal, according to the exemplary embodiment of the present invention.

A two-dimensional vector space is formed so that an L vector associated with the intensity of the left-channel audio signal in a given frequency band and an R vector associated with the intensity of the right-channel audio signal in the given frequency band form a given angle. When it is assumed that a user listens to a stereo-audio signal at a location where directions of left and right sound sources form a 60 degree angle, the angle between the L and R vectors may be set to be 60 degrees in the two-dimensional vector space. In the two-dimensional vector space formed by the L and R vectors, an M vector associated with the intensity of the mono-audio signal is expressed as a sum of the L and R vectors. Since the user listens to the stereo-audio signal having an intensity corresponding to the size of the M vector in the direction of the M vector at the location where the directions of the left and right sound sources form a 60 degree angle, the M vector may be expressed as a sum of the L and R vectors.

The parameter encoding unit 330 of FIG. 3 encodes information about an angle θp between the M and L vectors or an angle θq between the M and R vectors, instead of information about the IID and IC, as a parameter for determining the intensities of the left-channel and right-channel audio signals in the given frequency band.

Instead of encoding the angle θp or θq itself, a cosine value such as cos θp or cos θq may be encoded. When an attempt is made to encode and insert information about the angle into a bitstream, quantization is required. Accordingly, the cosine value of the angle is encoded in order to minimize a loss that occurs during quantization.

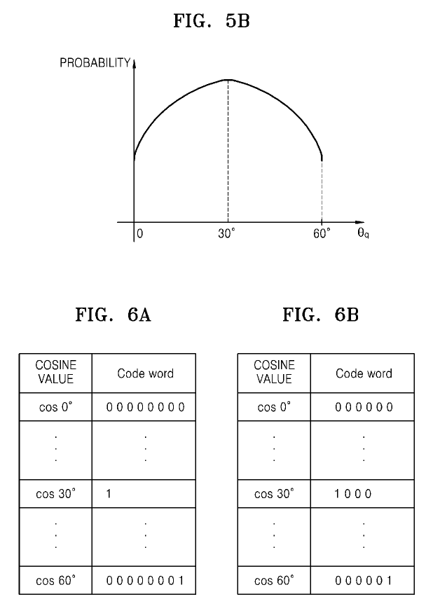

The angle θq between the M and R vectors has different probability distributions according to frequency bands. This will now be described in greater detail with reference to FIGS. 5A and 5B.

FIGS. 5A and 5B are graphs illustrating probability distributions of an angle between vectors associated with the intensities of a right-channel audio signal and a mono-audio signal, that is, the angle θq between the M and R vectors.

Referring to FIG. 5A, the angle θq in a low-frequency band is highly likely to be 30 degrees. Since a stereo-audio signal in the low-frequency band is more likely to be simultaneously played back through two channels than to be played back through either a left channel or a right channel, the probability that the angle θq in a low-frequency band is 30 degrees, which is half of 60 degrees, is high.

On the other hand, referring to FIG. 5B, probabilities that the angle θq in a high-frequency band is between 0 and 60 degrees are evenly distributed. Since the stereo-audio signal in the high-frequency band is more likely to be biased to either a left channel or a right channel than the stereo-audio signal in the low-frequency band, the probabilities that the angle θq in the high-frequency band is between 0 and 60 degrees are evenly distributed.

Since the probability distribution of the angle θq varies according to frequency bands, the parameter encoding unit 330 encodes the angle θq by using VLC tables different according to frequency bands. A case where a cosine value of the angle θq instead of the angle θq itself is encoded will now be illustrated with reference to FIGS. 6A and 6B.

FIGS. 6A and 6B illustrate VLC tables according to an embodiment of the present invention.

FIG. 6A illustrates a VLC table for encoding cosine values of a low frequency band. Referring to FIG. 6A, in order to encode cosine values cos θq of the low-frequency band, a cosine value cos 30° is mapped to a codeword composed of the least number of bits, and cosine values cos 0° and cos 60° are mapped to a codeword composed of the most number of bits.

FIG. 6B illustrates a VLC table for encoding cosine values of a high frequency band. Referring to FIG. 6B, a manner in which a cosine value cos 30° is mapped to a codeword composed of the least number of bits in order to encode cosine values cos θq of the high-frequency band is the same as the manner for the low-frequency band shown in FIG. 6A, because the probability that the angle θq is 30 degrees is highest even in the high-frequency band as can be seen from the probability distribution of FIG. 5B. However, the cosine value cos 30° is mapped to a 4-bit codeword, and cosine values cos 0° and cos 60° are each mapped to a 6-bit codeword. In other words, the number of bits that are used to encode the cosine values cos 0° and cos 60° is reduced compared with that shown in the VLC table of FIG. 6A. Since the probabilities that the cosine values cos 0° and cos 60° in the high-frequency band are encoded are higher than in the low-frequency band, the cosine values cos 0° and cos 60° in the high-frequency band are encoded using a small numbers of bits.

The parameter for determining the intensities of the left-channel and right-channel audio signals is only an example taken in order to describe a method of performing adaptive encoding on a plurality of VLC tables according to an exemplary embodiment of the present invention. Accordingly, parameters other than the above-exemplified parameter may also be encoded using VLC tables that differ according to frequency bands. For example, since the probability that a difference between phases of the left-channel and right-channel audio signals in the low-frequency band is small is higher than the probability that a difference between phases of the left-channel and right-channel audio signals in the high-frequency band is high, VLC tables that differ according to frequency bands may be selected in consideration of this probability distribution, and parameters may be encoded based on the selected VLC tables.

Referring back to FIG. 3, the down-mixing unit 340 adds the digital signals into which the ADC unit 110 has converted the left-channel audio signal and the right-channel audio signal so as to generate the mono-audio signal.

The mono-audio encoding unit 350 encodes the mono-audio signal generated by the down-mixing unit 340. The mono-audio encoding unit 350 encodes the mono-audio signal by using the VLC tables selected by the control unit 320, which differ according to frequency bands.

The multiplexing unit 360 multiplexes a parameter bitstream generated by the parameter encoding unit 330 and a bitstream of the mono-audio signal generated by the mono-audio encoding unit 350 so as to generate a bitstream of the stereo-audio signal.

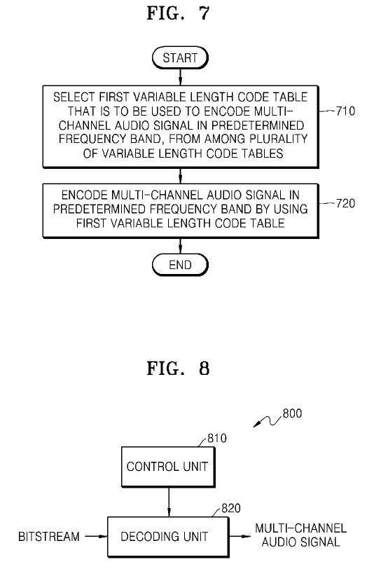

FIG. 7 is a flowchart illustrating a method of encoding a multi-channel audio signal, according to an exemplary embodiment of the present invention. Referring to FIG. 7, in operation 710, a multi-channel audio encoding apparatus selects a first VLC table that is to be used to encode the multi-channel audio signal in a given frequency band, from among a plurality of VLC tables. Since an intensity value or parameter value of the multi-channel audio signal has different probability distributions according to frequency bands, a single VLC table is selected from the VLC tables in order to encode the multi-channel audio signal in the given frequency band. Thus, the multi-channel audio signal is adaptively encoded in consideration of the different probability distributions. As described above, the VLC tables may be Huffman code tables, and the frequency bands may be set based on sub-bands.

Examples of a parameter of the multi-channel audio signal may include the parameter for determining the intensities of the left-channel audio signal and the right-channel audio signal of the stereo-audio signal in the given frequency band. As described above, the parameter for determining the intensities of the left-channel and right-channel audio signals may be determined using a vector associated with the intensity of the left-channel audio signal and a vector associated with the intensity of the right-channel audio signal.

In operation 720, the multi-channel audio encoding apparatus encodes the multi-channel audio signal in the given frequency band by using the first VLC table selected in operation 710. In other words, in operation 720, the multi-channel audio encoding apparatus encodes the multi-channel audio signal by using VLC tables selected in operation 710 which differ according to frequency bands.

FIG. 8 illustrates an apparatus 800 for decoding a multi-channel audio signal, according to an exemplary embodiment of the present invention. Referring to FIG. 8, the apparatus 800 for decoding the multi-channel audio signal includes a control unit 810 and a decoding unit 820.

The control unit 810 selects a variable length decode (VLD) table that is to be used to decode the multi-channel audio signal in a given frequency band, from among a plurality of VLD tables. In the exemplary embodiment of the present invention, decoding is performed using a characteristic of the multi-channel audio signal, which varies according to frequency bands. The characteristic of the multi-channel audio signal that varies according to frequency bands may be a probability distribution of an intensity or parameter value of the multi-channel audio signal. In order to perform decoding using a characteristic of the multi-channel audio signal, a VLD table suitable for encoding a frequency band of the multi-channel audio signal that is being currently decoded is selected from the VLD tables. The VLD tables may be Huffman code tables.

The decoding unit 820 decodes the multi-channel audio signal in the given frequency band by using the suitable VLD table selected from among the VLD tables by the control unit 810. The intensity or parameter of the multi-channel audio signal is decoded.

For example, a parameter of a stereo-audio signal which is being decoded may be a parameter for determining intensities of a left-channel audio signal and a right-channel audio signal of the stereo-audio signal or a parameter for determining phases of the left-channel audio signal and the right-channel audio signal.

The parameter for determining the intensities of the left-channel audio signal and the right-channel audio signal may be a parameter generated by using a vector associated with the intensity of the left-channel audio signal and a vector associated with the intensity of the right-channel audio signal. The parameter for determining the phases of the left-channel audio signal and the right-channel audio signal may be a parameter associated with a difference between the phases of the left-channel audio signal and the right-channel audio signal.

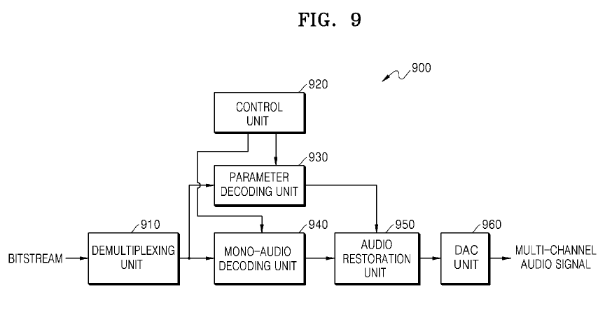

FIG. 9 illustrates an apparatus 900 for decoding a multi-channel audio signal, according to another exemplary embodiment of the present invention. Referring to FIG. 9, the apparatus 900 for decoding a multi-channel audio signal includes a demultiplexing unit 910, a control unit 920, a parameter decoding unit 930, a mono-audio decoding unit 940, an audio restoration unit 950, and a digital-to-analog conversion (DAC) unit 960.

The demultiplexing unit 910 receives a bitstream of the multi-channel audio signal and separates a bitstream of a parameter from a bitstream of a mono-audio signal.

The control unit 920 selects a VLD table that is to be used to decode the multi-channel audio signal in a given frequency band, from among a plurality of VLD tables. The VLD table is selected in consideration of a probability distribution of an intensity or parameter value of the mono-audio signal in the given frequency band.

When the control unit 920 selects VLD tables that differ according to frequency bands, the parameter decoding unit 930 decodes the parameter of the multi-channel audio signal by using the selected VLD tables. Similarly, the mono-audio decoding unit 940 decodes the intensity of the mono-audio signal by using the selected VLD tables.

The audio restoration unit 950 restores the multi-channel audio signal based on the parameter decoded by the parameter decoding unit 930 and the mono-audio signal decoded by the mono-audio decoding unit 940. For example, a mono-audio signal is transformed into a stereo-audio signal by using a parameter for determining intensities of a left-channel audio signal and a right-channel audio signal and a parameter for determining phases of the left-channel audio signal and the right-channel audio signal, the parameters having been decoded by the parameter decoding unit 930.

The DAC unit 960 converts the stereo-audio signal restored by the audio restoration unit 950 into an analog signal.

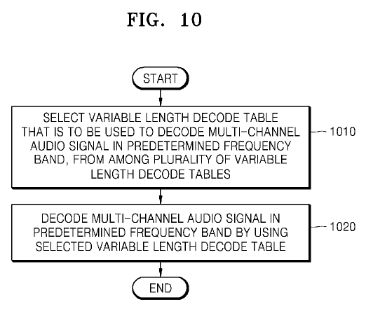

FIG. 10 is a flowchart of a method of decoding a multi-channel audio signal, according to an embodiment of the present invention.

Referring to FIG. 10, in operation 1010, a multi-channel audio decoding apparatus according to an exemplary embodiment of the present invention selects a VLD table that is to be used to decode the multi-channel audio signal in a given frequency band, from among a plurality of VLD tables. As described above, the VLD tables may be Huffman code tables, and the frequency bands may be set based on sub-bands.

In operation 1020, the multi-channel audio decoding apparatus decodes the multi-channel audio signal in the given frequency band by using the VLD table selected in operation 1010. The intensity or parameter of the multi-channel audio signal is decoded. Examples of a parameter of the multi-channel audio signal may include a parameter for determining the intensity of the multi-channel audio signal and a parameter for determining the phase of the multi-channel audio signal.

According to an exemplary embodiment of the present invention, a parameter of a multi-channel audio signal can be adaptively encoded in consideration of probability distributions of the parameter which differ according to a plurality of frequency bands. Thus, the multi-channel audio signal can be encoded at a compression rate higher than that in a related art.

Moreover, information about intensities of a left-channel audio signal and a right-channel audio signal of a stereo-audio signal can be encoded using a smaller number of parameters than in the related art. Thus, the multi-channel audio signal can be encoded at a compression rate higher than in the related art.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of encoding a multi-channel audio signal, the method comprising:
selecting a first variable length code (VLC) table that is to be used to encode the multi-channel audio signal in a first frequency band, from among a plurality of VLC tables; and
encoding the multi-channel audio signal by using the first VLC table,
wherein the plurality of VLC tables correspond to a plurality of frequency bands including the first frequency band, and
wherein, if the multi-channel audio signal is in a second frequency band, a second VLC table among the plurality of VLC tables is used to encode the multi-channel audio signal.

2. The method of claim 1, wherein the encoding of the multi-channel audio signal comprises encoding at least one of an intensity and a parameter of the multi-channel audio signal in the first frequency band by using the first variable length code table.

3. The method of claim 1, wherein the variable length code tables are Huffman code tables.

4. The method of claim 3, wherein the multi-channel audio signal is a stereo-audio signal.

5. The method of claim 4, wherein the parameter of the multi-channel audio signal is a parameter for determining an intensity of a left-channel audio signal in the first frequency band and an intensity of a right-channel audio signal in the first frequency band.

6. The method of claim 5, wherein the parameter for determining the intensities of the left-channel audio signal and the right-channel audio signal is information about one of an angle between a third vector associated with an intensity of a mono-audio signal and a first vector associated with an intensity of the left-channel audio signal, or an angle between the third vector and a second vector associated with an intensity of the right-channel audio signal in a vector space formed so that the first and second vectors form a given angle.

7. The method of claim 6, wherein the information about the angle is one of a cosine value of the angle between the first and third vectors and a cosine value of the angle between the second and third vectors.

8. The method of claim 1, wherein the frequency band is a sub-band.

9. A method of decoding a multi-channel audio signal, the method comprising:
selecting a first variable length decode (VLD) table that is to be used to decode the multi-channel audio signal in a fist frequency band, from among a plurality of VLD tables; and
decoding the multi-channel audio signal by using the first VLD table,
wherein the plurality of VLD tables correspond to a plurality of frequency bands including the first frequency band, and
wherein, if the multi-channel audio signal is in a second frequency band, a second VLD table among the plurality of VLD tables is used to decode the multi-channel audio signal.

10. The method of claim 9, wherein the decoding of the multi-channel audio signal comprises decoding at least one of an intensity and a parameter of the multi-channel audio signal in the first frequency band by using the first variable length code table.

11. The method of claim 9, wherein the variable length code tables are Huffman code tables.

12. The method of claim 11, wherein the multi-channel audio signal is a stereo-audio signal.

13. The method of claim 12, wherein the parameter of the multi-channel audio signal is a parameter for determining an intensity of a left-channel audio signal in the first frequency band and an intensity of a right-channel audio signal in the first frequency band.

14. The method of claim 13, wherein the parameter for determining the intensities of the left-channel audio signal and the right-channel audio signal is information about one of an angle between a third vector associated with an intensity of a mono-audio signal and a first vector associated with an intensity of the left-channel audio signal, or an angle between the third vector and a second vector associated with an intensity of the right-channel audio signal in a vector space formed so that the first and second vectors form a given angle.

15. The method of claim 14, wherein the information about the angle is one of a cosine value of the angle between the first and third vectors and a cosine value of the angle between the second and third vectors.

16. The method of claim 9, wherein the frequency band is a sub-band.

17. An apparatus for encoding a multi-channel audio signal, the apparatus comprising:
a control unit that selects a first variable length code (VLC) table that is to be used to encode the multi-channel audio signal in a first frequency band, from among a plurality of VLC tables; and
an encoding unit that encodes the multi-channel audio signal by using the first VLC table,
wherein the plurality of VLC tables correspond to a plurality of frequency bands including the first frequency band, and
wherein, if the multi-channel audio signal is in a second frequency band, the control unit selects a second VLC table among the plurality of VLC tables to encode the multi-channel audio signal.

18. The apparatus of claim 17, wherein the encoding unit encodes an intensity or a parameter of the multi-channel audio signal in the first frequency band by using the first variable length code table.

19. The apparatus of claim 17, wherein the variable length code tables are Huffman code tables.

20. The apparatus of claim 19, wherein the multi-channel audio signal is a stereo-audio signal.

21. The apparatus of claim 20, wherein the parameter of the multi-channel audio signal is a parameter for determining an intensity of a left-channel audio signal in the first frequency band and an intensity of a right-channel audio signal in the first frequency band.

22. The apparatus of claim 21, wherein the parameter for determining the intensities of the left-channel audio signal and the right-channel audio signal is information about one of an angle between a third vector associated with an intensity of a mono-audio signal and a first vector associated with an intensity of the left-channel audio signal, or an angle between the third vector and a second vector associated with an intensity of the right-channel audio signal in a vector space formed so that the first and second vectors form a given angle.

23. The apparatus of claim 22, wherein the information about the angle is one of a cosine value of the angle between the first and third vectors and a cosine value of the angle between the second and third vectors.

24. An apparatus for decoding a multi-channel audio signal, the apparatus comprising:
a control unit that selects a first variable length decode (VLD) table that is to be used to decode the multi-channel audio signal in a first frequency band, from among a plurality of VLD tables; and
a decoding unit that decodes the multi-channel audio signal by using the first VLD table.
wherein the plurality of VLD tables correspond to a plurality of frequency bands including the first frequency band, and
wherein, if the multi-channel audio signal is in a second frequency band, the control unit selects a second VLD table among the plurality of VLD tables to decode the multi-channel audio signal.

25. The apparatus of claim 24, wherein the decoding unit decodes an intensity or a parameter of the multi-channel audio signal in the first frequency band by using the first variable length code table.

26. The apparatus of claim 24, wherein the variable length code tables are Huffman code tables.

27. The apparatus of claim 26, wherein the multi-channel audio signal is a stereo-audio signal.

28. The apparatus of claim 27, wherein the parameter of the multi-channel audio signal is a parameter for determining an intensity of a left-channel audio signal in the first frequency band and an intensity of a right-channel audio signal in the first frequency band.

29. The apparatus of claim 28, wherein the parameter for determining the intensities of the left-channel audio signal and the right-channel audio signal is information about one of an angle between a third vector associated with an intensity of a mono-audio signal and a first vector associated with an intensity of the left-channel audio signal, or an angle between the third vector and a second vector associated with an intensity of the right-channel audio signal in a vector space formed so that the first and second vectors form a given angle.

30. The apparatus of claim 29, wherein the information about the angle is one of a cosine value of the angle between the first and third vectors and a cosine value of the angle between the second and third vectors.

31. A computer readable recording medium having recorded thereon a program for executing the method of claim 1.

32. A computer readable recording medium having recorded thereon a program for executing the method of claim 9.

33. The method of claim 1, wherein a number of the plurality of the VLC tables is (n×(p+1))×m, where n is a number of the frequency bands that the multi-channel audio signal can be transmitted in; p is a number of parameters used for encoding a multi-channel audio signal, and m is a number of channels of the multi-channel audio signal,
wherein n×m number of VLC tables among the plurality of the VLC tables are provided for encoding intensities of the multi-channel audio signal, and
wherein the parameters comprise information on at least one of intensity difference, correlation difference and phase difference between the channels of the multi-channel audio signal.

34. The method of claim 9, wherein a number of the plurality of the VLD tables is (n×(p+1))×m, where n is a number of the frequency bands that the multi-channel audio signal can be transmitted in; p is a number of parameters used for decoding a multi-channel audio signal, and m is a number of channels of the multi-channel audio signal,
wherein n×m number of VLD tables among the plurality of the VLD tables are provided for decoding intensities of the multi-channel audio signal, and
wherein the parameters comprise information on at least one of intensity difference, correlation difference and phase difference between the channels of the multi-channel audio signal.

35. The apparatus of claim 17, wherein a number of the plurality of the VLC tables is (n×(p+1))×m, where n is a number of the frequency bands that the multi-channel audio signal can be transmitted in; p is a number of parameters used for encoding a multi-channel audio signal, and m is a number of channels of the multi-channel audio signal,
wherein n×m number of VLC tables among the plurality of the VLC tables are provided for encoding intensities of the multi-channel audio signal, and
wherein the parameters comprise information on at least one of intensity difference, correlation difference and phase difference between the channels of the multi-channel audio signal.

36. The apparatus of claim 24, wherein a number of the plurality of the VLD tables is (n×(p+1))×m, where n is a number of the frequency bands that the multi-channel audio signal can be transmitted in; p is a number of parameters used for decoding a multi-channel audio signal, and m is a number of channels of the multi-channel audio signal,
wherein n×m number of VLD tables among the plurality of the VLD tables are provided for decoding intensities of the multi-channel audio signal, and
wherein the parameters comprise information on at least one of intensity difference, correlation difference and phase difference between the channels of the multi-channel audio signal.
